(19) United States
(12) Patent Application Publication
(10) Pub. No.: US 2009/0272521 A1
(43) Pub. Date: Nov. 5, 2009

(54) Stuffing Box for Pump Drive Head of Oil Well

(76) Inventors: Mariano Pecorari, Swarthmore, PA (US); Pietro Pecorari, Modena (IT)

Correspondence Address: MCGINN INTELLECTUAL PROPERTY LAW GROUP, PLLC, 8321 OLD COURTHOUSE ROAD, SUITE 200, VIENNA, VA, 22182-3817, US

(21) Appl. No.: 12/086,474

(22) PCT Filed: Dec. 14, 2005
(86) PCT No.: PCT/IT2005/000734

§ 371 Date: Sep. 18, 2008

(51) Int. Cl. E21B 33/03; F16J 15/56; F16J 15/18; E21B 33/02; E21B 33/08

(52) U.S. Cl. 166/84.2

(57) ABSTRACT

The improved stuffing box (7), adapted to be mounted inside an oil well head incorporating a rotary pump drive (50), includes: a rotating tube (2) having a stationary seal (3) coupled to a drive shaft (1) of the well pump; a substantial transition (6) in diameter, with a lower section (5) of the tube being a suitable outside diameter to receive the component parts of the stuffing box such that the outside diameter thereof can be smaller than the outside diameter (4) of the tube ahead of said transition (6) in diameter; a pressurized oil supply (P) for lubricating the rotary seal packing (15) at the opposed end of the packing from the internal pressure of the well; the tube being mounted rotatively (8) on the housing (9) such that the lower section of the tube can extend into a web (10) of the stuffing box (7); wherein the stuffing box comprises: located at the bottom end (12) of the tube, an axial stop ring (13), a retaining ring (14) for a first packing (15), followed by a spring (16) mounted within jackets (17), for abutting the spring against the first packing (15) and a second packing (18); an adjustment ring (19) held against said second packing (18) by at least one screw (20) having a conical end (21) received inside at least one mating conical seat (22) formed in the adjustment ring.

The invention relates to an improved stuffing box for the pump drive head of an oil well, which stuffing box is placed between the head installed at the pipe top end of an oil well and the oil well for driving the well pump, the latter being usually a positive displacement type of rotary pump with a progressing helical cavity, and is to a novel design making for ease of assembly and replacement as well as for extended life.

Known in the state of the art are several different ways of driving the pump shaft through its top end, all aimed at providing the most suitable drive for a flow rate from the oil well.

The state of the art also provides various arrangements of parts in the aforesaid stuffing box, as the latter is liable to lose its sealing properties from damage caused by small cuttings or slime entrained in the oil upflow.

In addition, pump downtime for servicing should be the shortest possible, since clogging of the pump with the mixed fluid it is processing involves cost-intensive procedures to bring the well back to operation. Accordingly, quick replacement of affected parts is essential if pump downtime is to be minimized.

From the state of the art as represented by Canadian Patent Application CA 2436924 A1, a pump head drive with an integral stuffing box is known, wherein the stuffing box has been shifted to a location atop the rotary drive, using a stationary inner pipe attached to the coupling flange at the top end of the well pipe. The document also discloses a modification having a rotating inner tube and a stuffing box, the latter with a rotary seal placed below the drive and a stationary seal placed between the tube and the pump input shaft, above the drive and the rotating tube bearings. Additionally, the packing of the rotary seal is supplied lubricating oil under pressure to resist the well pressure and keep the packing lubricated. This arrangement of bearings and packing rotary seal is quite inconvenient to work upon in either of the versions provided, with a stationary inner pipe or with the rotating tube, because the bearings and rotary shaft drive are to be taken down first, followed by the packing of the rotary seal, which is a labor- and time-intensive procedure.

The state of the art further provides, as described in International Patent Application WO 2004/092539 A1, a pump head drive with an integral stuffing box, wherein the stuffing box has been shifted to a tube having at least two different diameters and being rotated together with the shaft, coaxially therewith. The small outside diameter of the tube carries the rotary seals, for sealing said tube to the body of the stuffing box; stationary seals are provided at the coupling of the tube to the shaft. The provision of a retaining ring allows the stationary and rotary seals to be taken down together with the tube and associated parts with the seals within the stuffing box. This document also describes a packing design whereby oil under pressure is supplied into the stuffing box on the opposed side from the well to lubricate the packing and prevent balancing back pressure from forcing crude well oil up between the packing and the rotating tube. The thrust from the well pressure is transferred, through the stuffing box seals and intermediate members, to an axial thrust bearing received in the diameter transition section of the tube. In use, as well as at the assembly stage, the thrust bearing is often damaged in consequence of the combined tolerances of contiguous parts within the stuffing box, this tolerance value varying and being difficult to set and control. While the arrangement makes for easier replacement of members inside the stuffing box, the life span of the bearing seldom matches that of the stuffing box packing alone.

For best performance of the packing, an oil back pressure is applied which involves the provision of a hydraulic circuit, unless a hydraulic drive is being used for driving the pump, in the head or near the well.

With this design, the packing of the rotary seal is easier to take down, but is made more difficult to install and adjust by the large dimensional difference of the rotary seal components, namely the packing and associated rings, failing to invariably produce the same cumulative tolerance or a consistent train of tolerances. The combined tolerances of the rings and the packing cannot be controlled with certainty, and on account of the large number of components, can vary widely. In operation, the train of tolerances cannot always be held within an admissible range with any accuracy.

Finally, the state of the art, as represented by U.S. Pat. No. 5,244,183, provides a stuffing box wherein positive sealing is achieved by means of a liquid lubricant injector and an accumulator effective to maintain a back pressure downstream of the packings with respect to the pressurized environment in which the stuffing box is connected. The accumulator is to supply the lubricant to the packings, should lubricant leak out past the latter in time, at a high pressure in order to avert the possibility of liquid from the pressurized environment penetrating through the packing and defeating a tight seal. The lubricant is replenished by manual intervention of personnel whenever the amount of lubricant stored in the accumulator requires topping up. Therefore, this lubricant supply arrangement requires human attendance for checking at intervals, on the accumulator load gauge, that the lubricant level is maintained.

The above-outlined state of the art is susceptible to considerable improvement as to the provision of a stuffing box which can be coupled to a head with the pump drive, obviate the drawbacks mentioned above by enabling the servicing operations to be carried out more effectively, reliably, and in less time; in addition, the demand for inspections to check on the condition of the drive downhole, including the packing rotary seal, for proper performance should be more scattered.

Thus, the technical problem awaiting solution is the provision of a stuffing box which can be coupled to a pump drive head of an oil well, as well as used in combination with existing drive heads that incorporate any types of hydraulic, belt or gear drive, said stuffing box being easily disassembled, ensuring an invariably positive and safe positioning of components, and smoothing the overall operation in the face of the effects of a tolerance train in the component parts. Another object is to provide a stand-alone stuffing box, in the sense that it can perform to best suit the packing requirements, even where the drive is provided by an electric motor and in the presence of liquid lubricant/pressurized oil within or near the drive, thereby making human attendance to the supply of liquid lubricant for the packings unnecessary.

The invention solves the above technical problem by providing a stuffing box adapted to be coupled to an oil well head incorporating a rotary pump drive, the stuffing box comprising: a rotating tube having a stationary seal coupled to the driveshaft of the well pump and a substantial transition in diameter, with a lower section of the tube being a suitable outside diameter to receive the component parts of the stuffing box such that the outside diameter thereof can be smaller than the outside diameter of the tube ahead of said transition in diameter; a pressurized oil supply for lubricating the rotary seal packing at the opposed end from the packing as relates to the internal pressure of the well; the tube being carried rotatively at the housing such that the lower section of the tube will extend into a web of the stuffing box; characterized in that, the stuffing box comprises: located at the bottom end of the tube, an axial stop ring, a retaining ring for a first packing, followed by a spring mounted within jackets, for abutting the spring against the first packing and a second packing; an adjustment ring urged against said second packing by at least one screw having a conical end received inside at least one mating conical seat formed in the adjustment ring.

By providing in a preferred embodiment, the adjustment ring is urged against the packing by at least two or more screws with conical end in respective conical seats formed in the ring.

By providing in another preferred embodiment, the pressurized oil for lubricating the packings is supplied to the region between the first and the second packing of the stuffing box.

By adopting in another preferred embodiment, at least one bull ring is provided between the adjustment ring and the diameter transition of the tube.

By adopting in a further preferred embodiment, at least one spacer ring with cam is provided between the adjustment ring and the diameter transition of the tube to act on a radially reciprocated rod connected to a pressurized lube oil feed pump.

By providing in another embodiment, said pressurized oil feed pump comprises a piston, reciprocated inside a cylinder sleeve by said rod, having a first compression spring with a high linear load coefficient interposed and having at the other piston end a second suction compression spring arranged to urge the piston along its return stroke; the second spring having a much lower linear load coefficient than the first.

By providing in another preferred embodiment, said piston has at least one tang arranged to prevent said second spring from becoming fully compressed between the piston and the cylinder head.

By providing in another preferred embodiment, said piston has at least one tang arranged to prevent said first spring from becoming fully compressed between the piston and said reciprocating rod.

By providing in another preferred embodiment, the reciprocating rod is formed with a tang arranged to prevent said first spring from becoming fully compressed between the piston and said rod.

By providing in another preferred embodiment, the body of the reciprocating piston pump is connected removably to the cylinder sleeve.

Finally, by providing in a preferred embodiment, a pressurized oil feed pump has the reciprocating rod and first spring received in a seat formed directly in the web of the stuffing box.

One embodiment of the invention is illustrated, by way of example only, in the accompanying five drawings, wherein

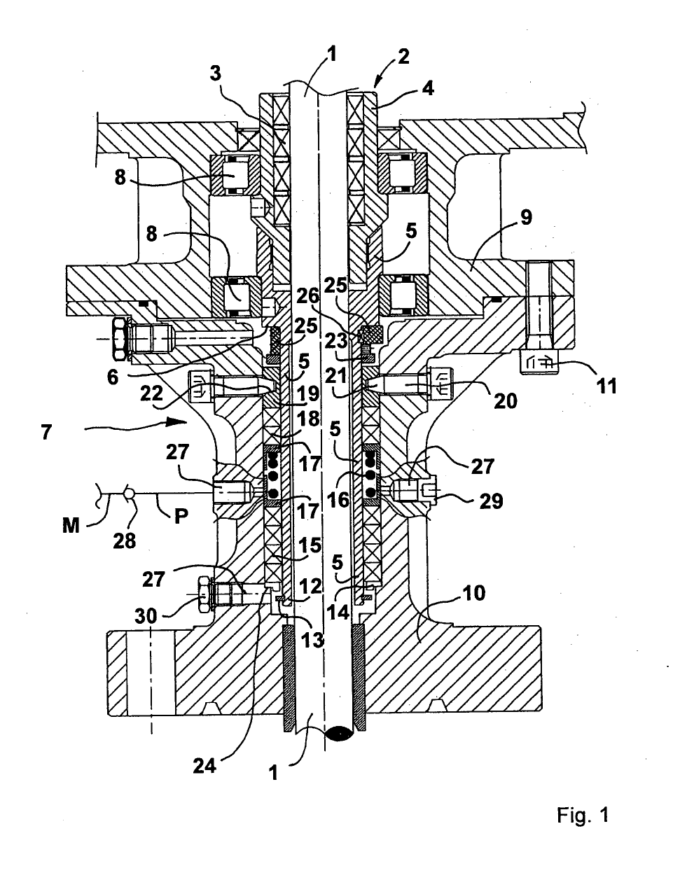

FIG. 1 is a longitudinal section view of the improved stuffing box according to the invention, showing the overall design of the stuffing box with packings lubricated under externally generated pressure, and the rotary bearings of the tube;

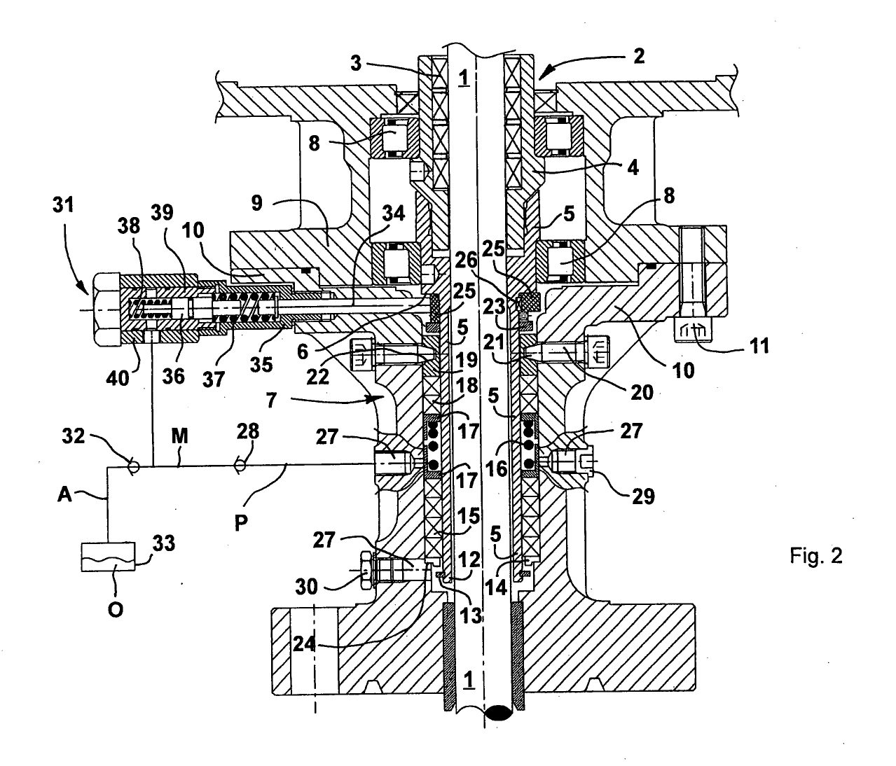

FIG. 2 is a longitudinal section view of the improved stuffing box according to the invention, similar to the preceding Figure, showing the packings lubricated under oil pressure generated by means of a variable delivery pump directly connected to the stuffing box, along with a diagram of the simplest possible form of hydraulic circuit;

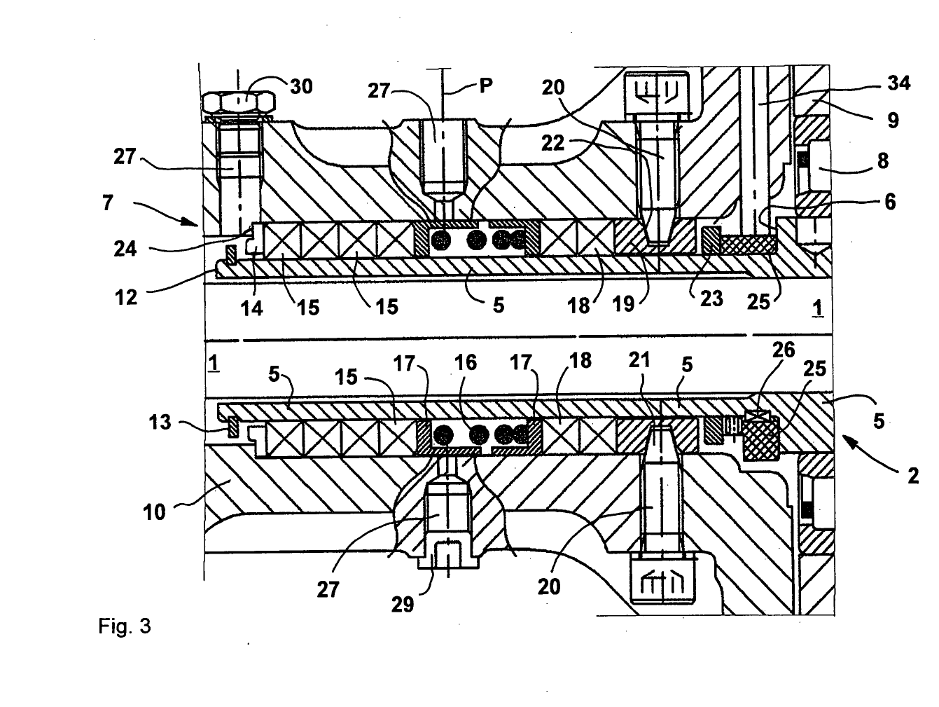

FIG. 3 is an enlarged sectional view of the stuffing box alone as shown in the preceding Figure;

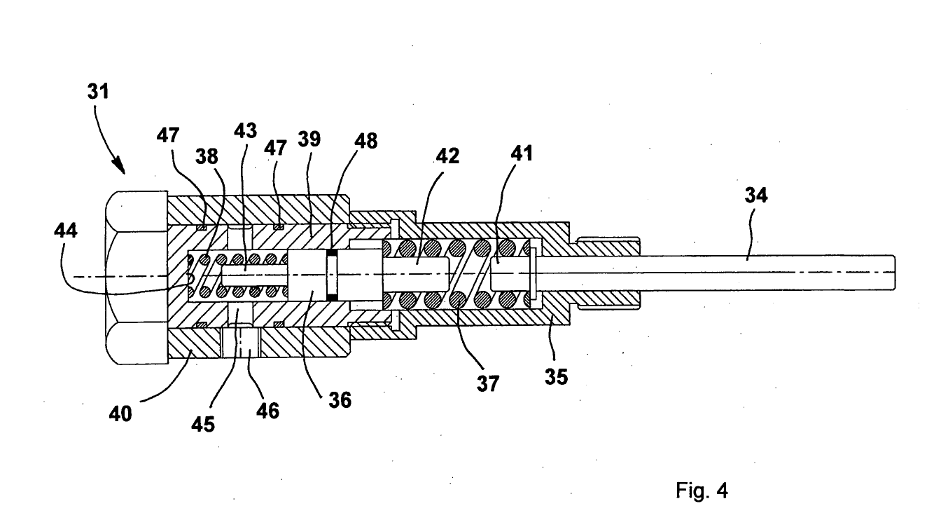

FIG. 4 is a sectional view of the variable delivery pump alone as shown in FIG. 2;

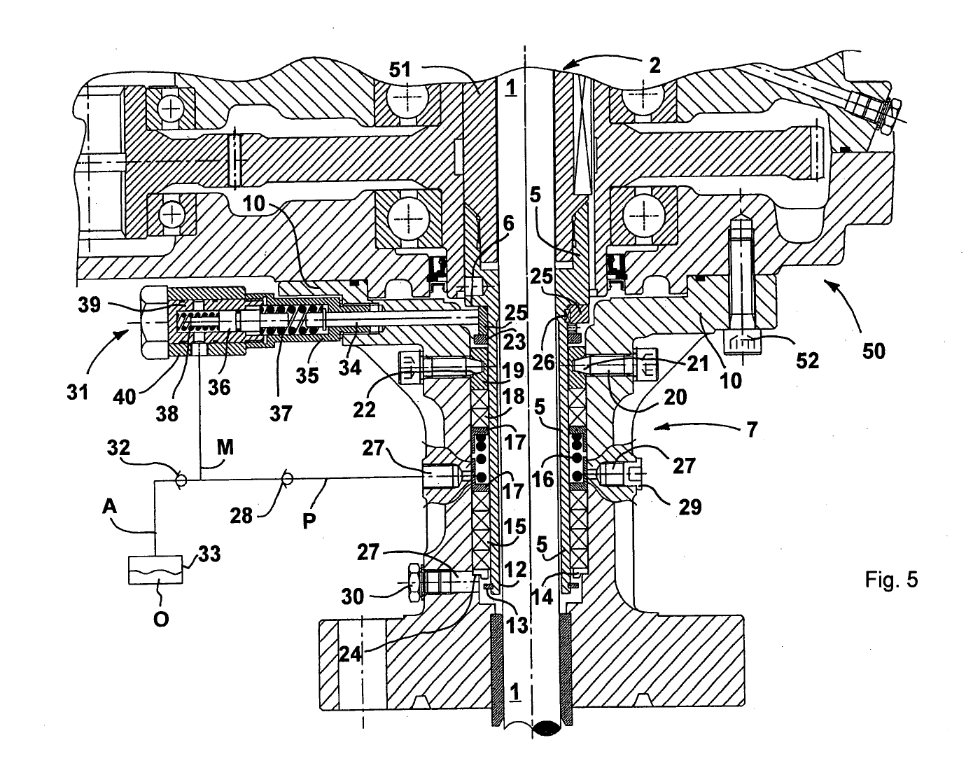

FIG. 5 is a longitudinal section view of the improved stuffing box according to the invention, as mounted to a well pump with an integral gear drive and pressure oil lubricated packings same as in FIG. 2, along with a diagram of the simplest possible form of hydraulic circuit.

Shown in FIG. 1 is the rotating shaft 1, driving rotatively the positive displacement pump with progressing helical cavity, not shown, and being connected to the rotating tube 2 that incorporates the stationary seal 3, conventionally coupled to said shaft and no further described here. The tube 2 is split into halves, namely: an upper section 4 for connection to the shaft 1, receiving the stationary seal 3, and a lower section 5 including a substantial transition 6 in diameter and a lower tube section whose outside diameter is adequate to enclose the component parts of the stuffing box 7 such that they can show a smaller outside diameter than the tube ahead of said diameter transition 6. The tube 2 is carried rotatively through roll bearings 8 by the housing 9, such that said lower section 5 extends into the web 10 of the stuffing box 7. The web 10 and housing 9 are held together by screw fasteners 11. The stuffing box includes, starting from the bottom end 12: an axial stop ring 13, a retaining ring 14 for the first packing 15, and a spring 16 received in jackets 17 for the spring to abut against said first packing 15 and a second packing 18. An adjustment ring 19 is urged against said second packing 18 by means of screws 20 having a conical end 21 and being driven in/out from outside the web 10. At the assembling stage, with the screws 21 taken out of their conical seats 22 in the adjustment ring 19, the spring 16 holds the second packing and the adjustment ring pressed against said diameter transition 6, bull ring 23, and spacer or cam 25. The spacer ring or cam, where provided, is entrained rotatively by the tube through the tongue 26. The stuffing box assembly is held between said adjustment ring 19 and the detent 24 on the inner surface of the web 10 where the packing is received. The web 10 is formed with hydraulic communication holes 27 upstream of the first and second packings. The hole 27 located upstream of the second packing has a lubricating oil supply line P connected hydraulically thereto for the first and second packings, the line P including a check valve 28 to stop oil from flowing back in the event of the pressure of the supply circuit M being lower than the pressure inside the stuffing box 7. The holes can be plugged off 29 or covered with detachable caps 30.

Another embodiment, shown in FIG. 2, is as described in connection with FIG. 1, but additionally includes a reciprocating piston pump 31 connected to the single delivery/suction conduit M upstream of the check valve 28. Another check valve 32 is arranged to isolate the delivery/suction conduit M from the suction conduit A connected to a reservoir 33 of lube oil O. The delivery pump 32 is operated by the rod 34 contacting said annular cam 25. Thus, at each revolution of the shaft 1, and accordingly of the tube 2 by its lower section 5, the rod 34 is displaced to allow operation of the pump 31. The rod is coupled to the pump body 35 in axially slidable relationship therewith, the body 35 being received in the web 10 of the stuffing box 7 in line with said annular cam 25. Said rod acts axially on the piston 36 through the compression spring 37, the latter displacing the piston when the combined force from the delivery pressure in the branch M and the compressive force from the suction spring 38 is lower than the compressive force from the compression spring 37. Since the back pressure in the delivery branch M varies, as vary the reaction forces of the compressions exerted by the springs 37 and 38, the pump 31 is bound to operate as a variable displacement pump, that advantageously increases its displacement correspondingly as the pressure in the pressure branch P of the circuit decreases, up to the highest displacement value allowed by design of its stroke length/diameter. Conversely, its displacement decreases correspondingly as the pressure in the pressure branch P of the circuit increases, down to nil upon the circuit branch P attaining its highest pressure setting.

FIG. 2 also shows the sleeve 39 wherein the piston 39 slides, which sleeve is received in the enclosing jacket 40 for conventional connection to the delivery/suction branch M.

FIG. 4 shows, to complete the description of the pump 31, a tang 41 on said rod 34, which tang is, jointly with a first tang 42 on said piston 36, effective to prevent the compression spring 37 from becoming fully compressed. Likewise, a second tang 43 on said piston prevents the suction spring 38 from being squeezed against the cylinder head 44 that closes off the sleeve 39. Also provided are radial ports 45 through the sleeve 39 for connection to the hydraulic circuit, via the communication hole 46 in the jacket 40. Seal rings 47 on either side of said radial ports 45 and a seal ring 48 on the piston 36 are provided as customary.

FIG. 5 shows the stuffing box 7 mounted directly to a rotary drive for the shaft 1, using conventional gears 50, in a manner no further described herein. Where the stuffing box joins the drive, one embodiment provides for the upper section of the rotating tube 2 to be coupled such that the stuffing box seals can be taken down without disassembling the drive, as fully described in Published International Patent Application WO 2004/092539 A1. Thus, disassembling the stuffing box for servicing involves no preliminary disassembly of the drive to the pump shaft 1, as by releasing the screws 52. All the other details shown are similar to those shown in the previous Figures.

The stuffing box illustrated is assembled by fitting the component parts of the stuffing box 7 sequentially onto the smaller outside diameter of the tube 2, or if advantageously provided in two sections, onto the upper and lower sections 4 and 5. The first rings to be fitted are the spacer or cam 25 and the bull ring 23; these are then followed by the adjustment ring 19 and the second packing 18 with the two jackets 17 and the spring 16. The first packing 15 and the retainer ring with the outside stop ring 13 on the bottom end 12 of the rotating tube are inserted next. The assembly thus put together is held to the rotating tube by said axial stop ring 13 and is biased to said diameter transition 6 by the spring 16. The rotating tube is mounted in the respective rotary bearings 8, and together with the housing 9, can be mounted on the stuffing box 7 and fastened to the web 10. Finally, the screws 20 are tightened down to bring their conical ends 21 into engagement with the conical seats 22 in the adjustment ring 19; these parts being thus held tightly against the detent 24 in the packing housing. Their positions are set by the positions of the holes for the screws 20 and said detent 24 in the web 10 of the stuffing box.

The disassembly procedure for servicing is similar to the assembly procedure, and benefits from the ability to have the position of the abutment ring 19 defined unmistakably and irrespectively of the rings or the packings that intervene between it and the diameter transition 6 in said rotating tube 2.

The variable displacement piston pump 31, shown in FIGS. 2, 4 and 5, operates as follows. The piston 36 is moved through the rod 34 being acted upon by the cam 25. The piston stroke is positive and predetermined by the cam lift, when the delivery pressure in the branch M is much lower than the difference in compressive force between the springs 37 and 38. Advantageously, the suction spring 38 has a comparatively low coefficient K38 whereby the spring can yield easily, yet be adequate to draw oil O from the reservoir 33 past the check valve 32. During the suction phase the check valve 28 is closed by the pressure that prevails in the branch P of the circuit. The coefficient K37 of compression spring 37 is instead much higher than the former coefficient, and at low delivery pressures provides an almost rigid push-only connection of the rod 34 with the piston 36. Thus, the pump operates at maximum displacement and at a proportional delivery rate to the number of revolutions (lifts of cam 25) input to the shaft 1. As the stuffing box 7 is filled, the pressure in the branch P increases, and resists the movement of piston 36. The delivery pressure, as calculated over the piston area, produces a force that, when added to the reaction force of spring 38, opposes the pumping movement of the piston, and owing to the resiliency of the compression spring 37, also the reciprocating movement applied to the rod 34 by the cam 25.

As the pressure in the delivery branch M and P rises upon the check valve 28 being opened, if the internal pressure of the stuffing box is lower than the delivery pressure, oil keeps being pumped into the stuffing box.

The oil pumped to the region between the first 15 and the second 18 packing pressurizes the stuffing box, thereby providing the best possible operating condition for the packings and preventing unclean crude oil from penetrating through the first packing 15.

The pump 31 can be designed to have appropriate stroke length/diameter dimensions, or compression coefficients K37 and K38 of the springs 37 and 38, to set the pressure inside the stuffing box at a definite value. The increased pressure in the branch P causes the hydraulic resistance to the piston movement to increase such that at a certain point the stroke becomes nil and the pump 31 ceases pumping oil. As the pressure in the delivery branch increases, the compression spring 37 begins to yield, and at the calibrated pressure level, yields completely, so that the motion of the rod 34 under the action of the cam 25 is no longer transferred to the piston 36, i.e. the pump enters a state of no displacement.

At a subsequent time, as the pressure inside the stuffing box decreases, usually in consequence of leakage past the packing 15, the pump 31 can again increase its displacement, because a lower pressure in the delivery branch M allows the spring 37 to move the piston 36, however slightly, and the pressure generated by the piston closes check valve 32 and opens check valve 28, thereby admitting more oil and restoring the stuffing box 7 to its desired pressure.

The operation of the pump 31 incorporated to the stuffing box as described above allows much longer oil well inspection and/or servicing intervals, and extends the life span of the packings when operated with the back pressure from the lubricating oil acting against the crude oil that issues from the well.

The advantages of this invention are the following: the component parts of the stuffing box are easily mounted on the rotating tube irrespective of the manufacturing tolerances of the individual parts; adjustments made by means of the adjustment ring 19 and the screws 20 with a conical head 21 into conical seats 22 in the ring, allow the component parts of the stuffing box to be positioned unmistakably and independently of the location of the diameter transition 6 on said rotating tube. In addition, the pressurized oil lubricant is supplied to the packings, for best performance of the latter, from a pump which is driven directly off the drive shaft of the positive displacement rotary pump with progressing helical cavity of the oil well, in an unrelated manner to the availability of pressurized oil on the spot, without requiring complicated and expensive oil pressurizing circuits. Finally, the reciprocating variable displacement pump and the simple hydraulic circuit supplying the oil under pressure are quite simple, inexpensive to manufacture and service, and allow much longer intervals between oil well inspections and/or check-ups.

In practicing the invention, the dimensions and construction details may be other than those specified hereabove, although technically equivalent, without departing thereby from the juridical domain of the present invention. Thus, although less conveniently, a plain ring spacer could be substituted for the spacer ring or cam 25 where the stuffing box requires no incorporated pump.

1. A stuffing box adapted to be coupled to an oil well head incorporating a rotary pump drive, which stuffing box includes:
a rotating tube having a stationary seal coupled to a drive shaft of the well pump;
a substantial transition in diameter, with a lower section of the tube being a suitable outside diameter to receive the component parts of the stuffing box such that the outside diameter thereof can be smaller than the outside diameter of the tube ahead of said transition in diameter;
a pressurized oil supply for lubricating the rotary seal packing at the opposed end of the packing from the internal pressure of the well;
the tube being carried rotatively on a housing such that the lower section of the tube can extend into a web of the stuffing box;
wherein the stuffing box comprises:
located at the bottom end of the tube, an axial stop ring, a retaining ring for a first packing, followed by a spring mounted within jackets, for abutting the spring against the first packing and a second packing; and
an adjustment ring held against said second packing by at least one screw having a conical end received inside at least one mating conical seat formed in the adjustment ring.

2. The stuffing box according to claim 1, wherein the pressurized oil for lubricating the packings is supplied to a region between the first and the second packing of the stuffing box.

3. The stuffing box according to claim 1, wherein at least one bull ring is provided between the adjustment ring and the diameter transition of the tube.

4. The stuffing box according to claim 1, wherein the adjustment ring is held against the packing by at least two or more screws with conical end in respective conical seats formed in the ring.

5. The stuffing box according to claim 1, wherein at least one spacer ring with cam is provided between the adjustment ring and the diameter transition of the tube to act on a radially reciprocated rod connected to a pressurized oil feed pump.

6. The stuffing box according to claim 5, wherein said pressurized oil feed pump comprises a piston, reciprocated inside a cylinder sleeve by said rod, having: a first compression spring with a high linear load coefficient interposed and having at the other piston end; a second suction compression spring arranged to urge the piston along its return stroke; the second spring having a much lower linear load coefficient than the first.

7. The stuffing box according to claim 6, wherein said piston has at least one tang arranged to prevent said second spring from becoming fully compressed between the piston and the cylinder head.

8. The stuffing box according to claim 6, wherein said piston has at least one tang arranged to prevent said first spring from becoming fully compressed between the piston and said reciprocating rod.

9. The stuffing box according to claim 6, wherein the reciprocating rod is formed with a tang arranged to prevent said first spring from becoming fully compressed between the piston and said rod.

10. The stuffing box according to claim 6, wherein the body of the reciprocating piston pump is connected removably to the cylinder sleeve.

11. The stuffing box according to claim 6, wherein the pressurized oil feed pump has the reciprocating rod and first spring received in a seat formed directly in the web of the stuffing box.

12. The stuffing box according to claim 2, wherein at least one bull ring is provided between the adjustment ring and the diameter transition of the tube.

13. The stuffing box according to claim 2, wherein the adjustment ring is held against the packing by at least two or more screws with conical end in respective conical seats formed in the ring.

14. The stuffing box according to claim 2, wherein at least one spacer ring with cam is provided between the adjustment ring and the diameter transition of the tube to act on a radially reciprocated rod connected to a pressurized oil feed pump.

15. The stuffing box according to claim 4, wherein at least one spacer ring with cam is provided between the adjustment ring and the diameter transition of the tube to act on a radially reciprocated rod connected to a pressurized oil feed pump.
